(19) United States
(12) Patent Application Publication
(10) Pub. No.: US 2014/0096001 A1
(43) Pub. Date: Apr. 3, 2014

(54) WIRELESS COMMUNICATION DEVICE DATA LOGGING AND ACCESS SYSTEM

(71) Applicant: Kwamecorporation Ltd, London (GB)

(72) Inventor: Ferreira Zumbi, London (GB)

(21) Appl. No.: 14/040,155

(22) Filed: Sep. 27, 2013

(30) Foreign Application Priority Data
Sep. 28, 2012 (GB) GB1217463.7

(51) Int. Cl. G06F 3/0482; G06F 3/0481; G06F 3/0485

(52) U.S. Cl. CPC G06F 3/0482; G06F 3/0485; G06F 3/04817
USPC 715/719; 715/753

(57) ABSTRACT

A wireless communication device data logging and access system includes a communication network coupled with one or more databases and one or more mobile wireless communication devices. Computing hardware coupled to a data memory, a wireless communication interface and to a user interface is configured to execute computer readable instructions of one or more software applications stored in the data memory to cause the wireless communication device to generate a temporal log of communications made to and from the wireless communication device for enabling a graphical timeline presentations of the communications to be provided in chronological order via the user interface in one or more channels depending upon a nature of the communications; lists and/or icon presentations on the user interface of parties responsible for the communications and a representation of their mutual association; and a news portal of content published by the parties responsible for the communications.

### TECHNICAL FIELD

The present disclosure relates to wireless communication device data logging and access systems, for example to telephone data logging and access systems implemented using one or more software products stored on non-transient machine-readable data storage media, wherein the one or more software products are executable upon computing hardware of the systems. Moreover, the present invention also relates to methods of operating aforesaid wireless communication device data logging and access systems. Furthermore, the present invention also concerns software products stored on non-transient machine-readable data storage media, wherein the software products are executable upon computing hardware of the systems for implementing aforesaid methods.

### BACKGROUND

Contemporary telephone systems support communication via fixed land lines, and via wireless communication devices such as smart telephones. The devices are operable to communicate mutually via a telecommunications infrastructure hosting one or more proprietary services which automatically keep a log of telephone calls made by a given user, for example for invoicing and billing purposes.

As contemporary mobile telephones have progressively been provided with more powerful computing hardware and more data memory capacity, the mobile telephones have been capable of downloading software applications, known as “Apps”, via wireless communication, for example from various external databases known as “App stores”, and executing the software applications upon the computing hardware. Such software applications enable the mobile telephone to execute various “telephone directory” applications, which enable the mobile telephone to access, for example, telephone directories stored in databases and maintained remotely from the mobile telephone. Such functionality has resulted in contemporary mobile telephones providing facilities such as Facebook, Twitter and similar social media features; “Facebook” and “Twitter” are registered trade marks.

A contemporary problem which is encountered pertains to such known proprietary software applications not fully providing all functionalities which are of benefit to users of mobile telephones on which the software applications are executed. Moreover, known software applications are not able to be adapted to provide all such beneficial functionalities. As the programming code of such software applications is often not “open source”, it is virtually impossible for users to adapt the software applications to satisfy their requirement for providing all desired functionalities.

A known messaging system organizes and presents messages to users of the messaging system. This messaging system includes a mail-box module that receives messages and generates conversation threads from the messages. Messages received from different electronic message channels are optionally aggregated into a common conversational thread. Moreover, the conversation threads are also organized in a message interface and then presented to a user of the messaging system. Furthermore, the messaging system optionally includes a social networking system that stores social information about users, which can be used to organize conversation threads. Other features include a multi-mode message interface, and a method of adding contextual information to messages. In practice, it is found that the messaging system is not sufficiently flexible and/or straightforward for users to employ effectively.

### SUMMARY

The present invention seeks to provide wireless communication device data logging and access systems providing extended functionalities, referred to as “Life Beat” functionalities, for wireless communication devices, for example mobile telephones, by way of one or more software applications executable upon computing hardware of the wireless communication devices.

Moreover, the present invention seeks to provide methods of providing extended functionalities, referred to as “Life Beat” functionalities, for wireless communication device data logging and access systems for use with wireless communication devices, for example mobile telephones, by way of executing one or more software applications upon computing hardware of the wireless communication devices.

Furthermore, the present invention seeks to provide software applications executable upon computing hardware for implementing aforesaid methods of providing extended functionalities, referred to as “Life Beat” functionalities, for mobile telephones.

According to a first aspect, there is provided a wireless communication device data logging and access system as defined in appended claim 1: there is provided a wireless communication device data logging and access system, wherein the system includes a communication network coupled in communication with one or more databases and one or more mobile wireless communication devices, wherein each mobile wireless communication device includes computing hardware coupled to a data memory, to a wireless communication interface for exchanging data wirelessly with the communication network, and to a user interface for receiving instructions from a given user and for presenting information to the given user, and wherein the computing hardware is operable to execute one or more software applications stored in the data memory, wherein

the one or more software applications are operable to cause the wireless communication device:
(i) to generate a temporal log of communications made to and from the wireless communication device, for enabling a graphical timeline presentation of the communications to be provided in chronological order via the user interface in one or more channels depending upon a nature of the communications;
(ii) to generate lists and/or icon presentations on the user interface of parties responsible for the communications and a representation of their mutual association; and
(iii) to generate a news portal of content published by the parties responsible for the communications.

The invention is of advantage in that the system is capable of assisting the given user to cope with his or her portfolio of contacts and also provide information about the contacts in a more convenient manner.

Optionally, the wireless communication device data logging and access system is implemented such that data representative of the parties responsible for the communications are stored in at least duplicate in the data memory of the wireless communication device and on the one or more databases.

Optionally, the wireless communication device data logging and access system is implemented such that the wireless communication device is implemented as a smart mobile telephone, and the user interface is implemented as a touch-screen pixel display for enabling the given user to enter data to the wireless communication by swiping and/or tapping actions applied to the display.

Optionally, the wireless communication device data logging and access system is implemented such that the graphical timeline presentation is scrollable on the user interface by way of the given user applying a swiping motion in contact with the user interface.

Optionally, the wireless communication device data logging and access system is implemented such that the system is configured so that the given user is able to send a request via the communication network to search in contact lists of other parties which are associated with the given user. More optionally, the wireless communication device data logging and access system is implemented such that the system is configurable to define the other parties which are accessible to the given user for searching purposes.

Optionally, the wireless communication device data logging and access system is implemented such that the one or more software applications are operable to provide editing functionality for the given user to manage his or her list of parties contactable via the system.

Optionally, the wireless communication device data logging and access system is implemented such that the system is configured to enable the given user to contribute content to be included in the news portal of other parties of the system.

Optionally, the wireless communication device data logging and access system is configured to log at least one of:

(a) first uploading of audio and/or video data files to one or more mobile wireless communication devices;
(b) occasions of viewing and/or listening to audio and/or video data files; and
(c) dissemination of audio and/or video data files from a mobile wireless communication device to one or more mobile wireless communication devices.
More optionally, the system is configured to record an aggregated log of downloading, uploading, viewing and/or dissemination of the audio and/or video data files in respect of the one or more mobile wireless communication devices.

According to a second aspect, there is provided a method of operating a wireless communication device data logging and access system, wherein the system includes a communication network coupled in communication with one or more databases and one or more mobile wireless communication devices, wherein each mobile wireless communication device includes computing hardware coupled to a data memory, to a wireless communication interface for exchanging data wirelessly with the communication network, and to a user interface for receiving instructions from a given user and for presenting information to the given user, and wherein the computing hardware is operable to execute one or more software applications stored in the data memory, wherein the method includes:

(i) using the one or more software applications to cause the wireless communication device to generate a temporal log of communications made to and from the wireless communication device, for enabling a graphical timeline presentation of the communications to be provided in chronological order via the user interface in one or more channels depending upon a nature of the communications;
(ii) using the one or more software applications to cause the wireless communication device to generate lists and/or icon presentations on the user interface of parties responsible for the communications and a representation of their mutual association; and
(iii) using the one or more software applications to cause the wireless communication device to generate a news portal of content published by the parties responsible for the communications.

Optionally, the method includes storing data representative of the parties responsible for the communications at least in duplicate in the data memory of the wireless communication device and on the one or more databases.

Optionally, the method includes implementing the wireless communication device as a smart mobile telephone, and implementing the user interface as a touch-screen pixel display for enabling the given user to enter data to the wireless communication by swiping and/or tapping actions applied to the display.

Optionally, the method includes implementing the graphical timeline presentation in a scrollable manner on the user interface, wherein the graphical timeline presentation is thereby scrollable by way of the given user applying a swiping motion in contact with the user interface.

Optionally, the method includes implementing the system so that the given user is able to send a request via the communication network to search in contact lists of other parties which are associated with the given user. More optionally, the method includes configuring the system to define the other parties which are accessible to the given user for searching purposes.

Optionally, the one or more software applications are operable to provide editing functionality for the given user to manage his or her list of parties contactable via the system.

Optionally, the method includes configuring the system to enable the given user to contribute content to be included in the news portal of other parties of the system.

Optionally, the method includes logging at least one of:

(a) first downloading or uploading of audio and/or video data files to one or more mobile wireless communication devices;
(b) occasions of viewing and/or listening to audio and/or video data files; and
(c) dissemination of audio and/or video data files from a mobile wireless communication device to one or more mobile wireless communication devices.
More optionally, the method includes recording an aggregated log of downloading, uploading, viewing and/or dissemination of the audio and/or video data files in respect of the one or more mobile wireless communication devices. More optionally, the method includes providing a timeline presentation of aforesaid logging on one or more displays of the one or more communication devices.

According to a third aspect, there is provided a software product recorded on non-transient machine-readable data storage media, characterized in that the software product is executable upon computing hardware for implementing a method pursuant to the second aspect of the invention.

Optionally, the software product is downloadable as a software application from one or more databases via a communication network to one or more mobile communication devices for execution upon computing hardware thereof.

It will be appreciated that features of the invention are susceptible to being combined in various combinations without departing from the scope of the invention as defined by the appended claims.

### DESCRIPTION OF THE DIAGRAMS

Embodiments of the present disclosure will now be described, by way of example only, with reference to the following diagrams wherein:

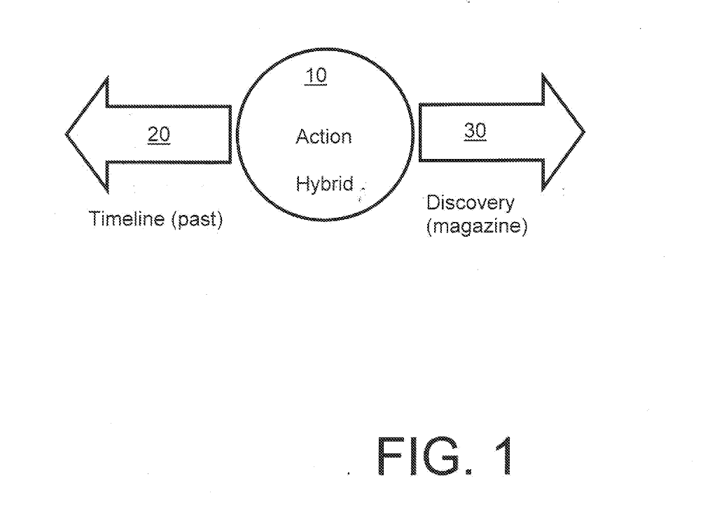

FIG. 1 is an illustration of a “Life Beat” context of the present invention;

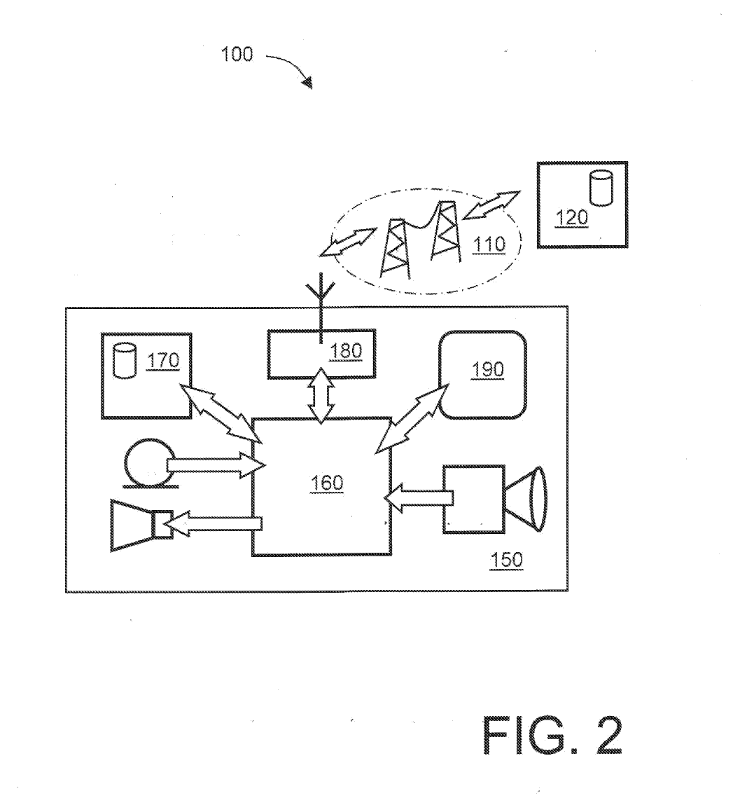

FIG. 2 is an illustration of a communication system which is configured to execute the present invention;

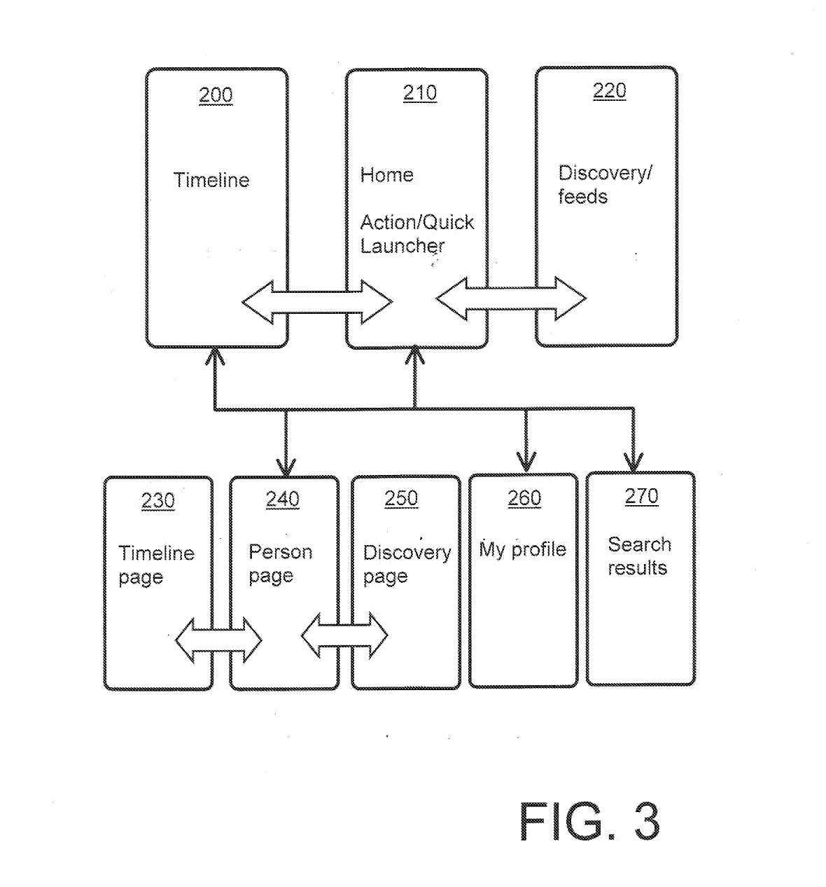

FIG. 3 is an illustration of Life Beat functionality provided on one or more communication devices of the system of FIG. 2;

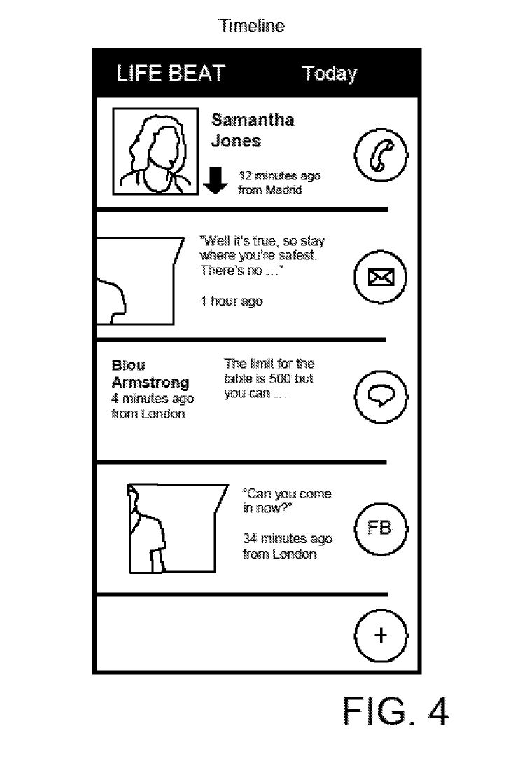

FIG. 4 is an illustration of a timeline graphical user interface presentation provided by the Life Beat timeline functionality;

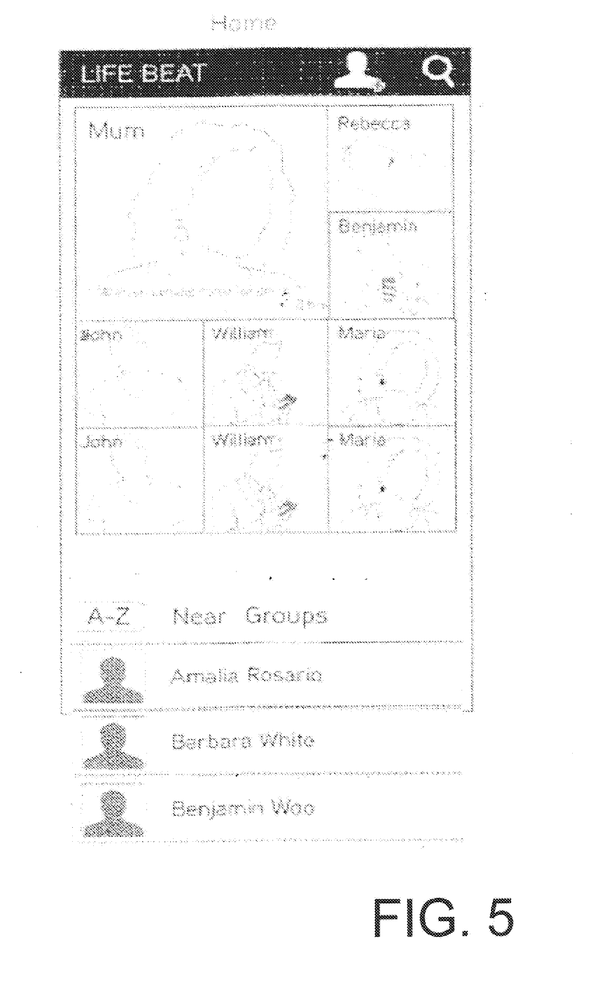

FIG. 5 is an illustration of a home graphical user interface presentation provided by the Life Beat home functionality;

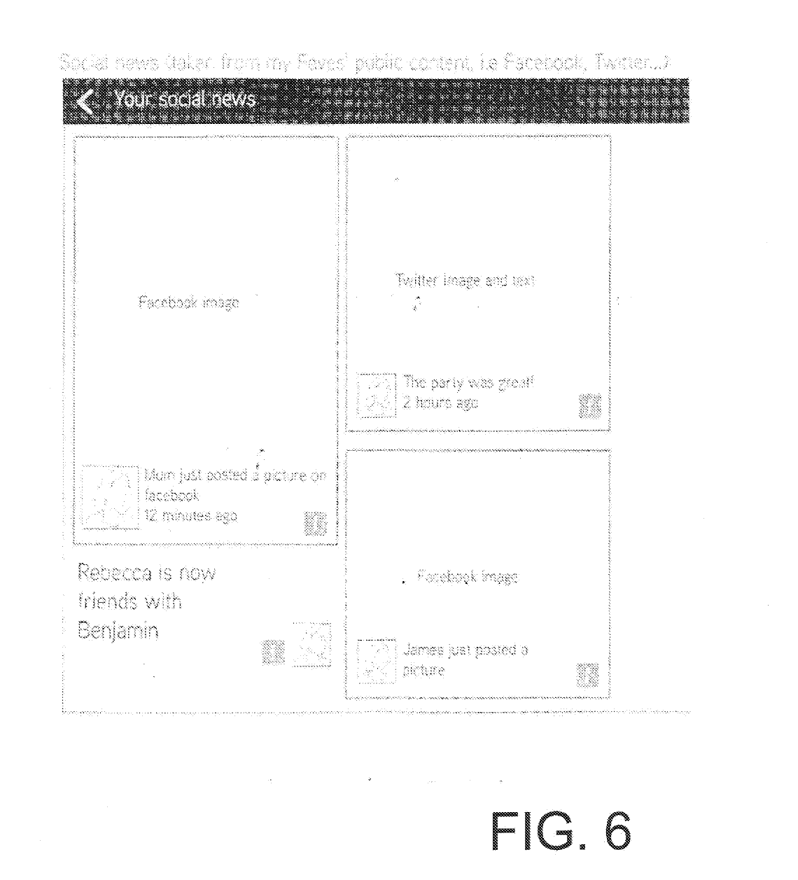

FIG. 6 is an illustration of a discovery graphical user interface presentation provided by the Life Beat discovery functionality; and

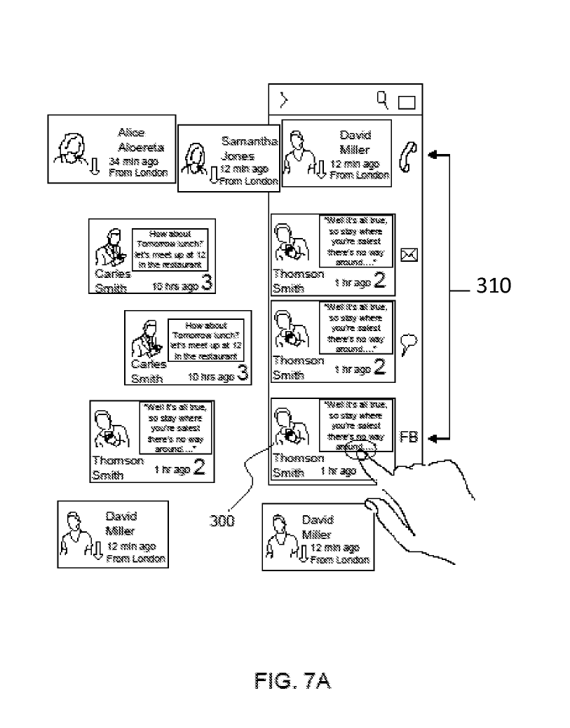

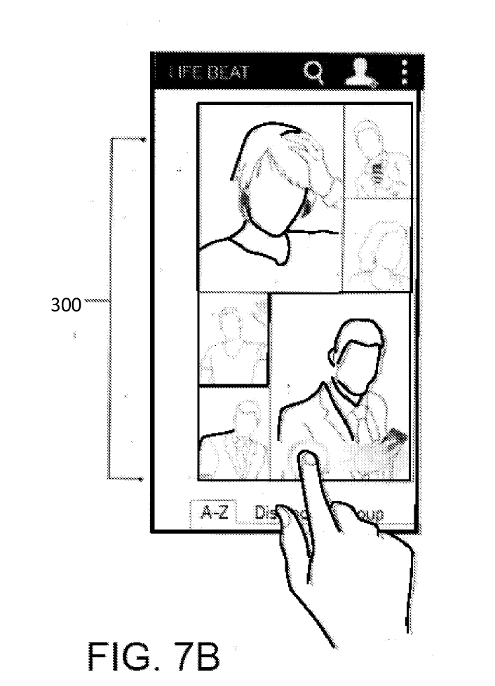

FIG. 7A and FIG. 7B are illustrations of channels of the Life Beat timeline functionality with entries presented in chronological order, together with quick access provided to a given user for accessing the timeline functionality.

In the accompanying diagrams, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

In overview, the present disclosure is concerned with telephone data logging and access systems which are capable of providing extended functionalities, hereinafter referred to as being “Life Beat” functionalities. The Life Beat functionalities are derived from an operating arrangement as depicted in FIG. 1, wherein a given user is contemplating executing an action 10, and has a past history timeline 20 as a guide of previous communications made within a telephonic communication system, and wherein a hybrid of the action 10 and past history timeline 20 guides a discovery magazine denoted by 30 which provides support for executing the action 10. In other words, the discovery magazine 30 provides a news portal in magazine layout. Optionally, the action 10 relates to at least one of: downloading of audio and/or video content, sharing of audio and/or video content with other users, and first viewing of audio and/or video by a given user. The timeline 20 provides a temporal log of dissemination of aforesaid audio and/or video content which, for example, is optionally aggregated for a plurality of users; the temporal log is beneficially used for tracing a degree of dissemination of the audio and/or video content, for example in a case of a product and/or service marketing campaign based on dissemination of marketing audio and/or video content having an element of entertainment. Moreover, the timeline 20 is optionally also used for tracking unauthorized audio and/or video file distribution, for example in a context of potential copyright infringement of such content.

Referring next to FIG. 2, the present disclosure is optionally implemented in a system indicated generally by 100, wherein the system 100 includes a wireless communication network 110, one or more remote databases 120 accessible to users of the system 100, and one or more mobile communication devices 150, for example one or more mobile telephones, one or more wireless-enabled personal computers (PC), one or more phablets, one or more tablet computers, personal digital assistants (FDA's), and similar. The one or more communication devices 150 each include computing hardware 160, which may, in turn, include a processor. Computing hardware 160 is coupled to associated data memory 170 and to a wireless interface 180. The computing hardware 160 is also coupled to a user-interface 190, for example to a touch-screen graphical user interface as included in advanced contemporary smart mobile telephones. Data memory 170 may include any of a variety of computer readable storage media or computer readable signal media of transitory and non-transitory forms. For example, data memory 170 may include media such as hard drives, CD-ROMs, DVD-ROMs, read-only memory, read-write memory

A given user employs his or her communication device 150 to make communications, for example telephone, calls to other users via the wireless communication network 110, as well as optionally accessing data from the one or more remote databases 120 accessible to users of the system 100, and also for uploading data to the one or more remote databases 120; such data optionally relates to audio and/or video content, for example one or more songs, song videos and similar. The communication device 150 is capable of providing particular functionalities in respect of data processing by way of the computing hardware 160 of the communication device being configured, arranged or otherwise operable to execute computer readable instructions incorporated within one or more software applications or portions of computer readable program code, known as “Apps”, stored in the data memory 170. The one or more software applications are provided either preloaded into the communication device 150 at its time of manufacture, or alternatively downloaded later by the given user onto his or her communication device 150. Conveniently, the software applications are available from an “App store” hosted at the one or more remote databases 120.

Referring next to FIG. 3, the communication device 150 of the given user, when executing computer readable instructions of a software application on the computing hardware 160 for implementing the present invention, is configured, arranged or otherwise operable to provide a collection of functionalities on the user interface 190, namely a timeline functionality 200, an action functionality 210 acting as a “home page” for actions (“Actions”) and for launching functionalities (“Quick Launcher”), and a discovery/feeds functionality 220. From the action functionality 210, the given user is able by interacting with the user interface 190 to migrate between a timeline page 230, a person page 240, and a discovery page 250. Moreover, the given user is also able, from the action functionality 210 to access a profile page (“My profile”) 260 and a search results page (“Search results”) 270.

The timeline functionality 200 is configured, arranged or otherwise operable to provide a unified communication log of all recent contacts with who the given user has, for example recently, been in communication; beneficially, the unified communication log also includes a record of one or more audio data files and/or video data files downloaded to the communication device 150 and/or the unified communication log also includes a record of dissemination of one or more audio files and video data files from the communication device 150 and intended recipients of such data files. Details of the communication log are optionally stored in the data memory 170, or at the one or more remote databases 120, or both; the communication log stored at the one or more remote databases 120 is beneficially employed by the system 100 for invoicing purposes to the given user and also for determining temporal communication load upon the communication network 110, wherein such temporal communication load information is beneficial for an operator of the network 110 to collate for determining where additional communication capacity is required in future when developing and evolving the communication network 110; determination of such additional communication capacity is especially pertinent when large data files, for example video data files are being communicated between communication devices coupled to the communication network 110. The timeline functionality 200 allows the given user to switch between a graphical timeline representation and a list view; this provides the given user with clear oversight of his or her use of the communication 150. The graphical timeline representation is implemented such that the given user is able to add actions to the timeline, for example reminders to contact other particular users. Moreover, the timeline functionality 200 also provides the given user with an editing history which documents all changes that the given user has entered onto the timeline, for example a history of actions added by the given user to the timeline. Optionally, by clicking or swiping motions applied by the given user to a given action included on the graphical timeline representation, the given user is capable of invoking one or more software applications for implementing the given action, for example sending a reminder, sending a notification, sending an short message service (SMS) communication, an e-mail or similar.

The action functionality 210 provides a home page and provides overview information, for example favourite (“fave”) user contact details, for example at a top display region of the user interface 190, spatially nearby user contact details, A-Z listed contacts and similar. From the action functionality 210, the given user is capable of invoking functions such as: “Quick scroll”, “Search”, “Hide a contact”, “Pin a contact”, “Change Status of a contact”, “Add a contact”, “See my profile”. “Quick scroll” provides via the user interface 190 a quick scrolling viewing of information, for example for executing rapid manual searching through lists of contacts and related data presented on the user interface 190; optionally, such “Quick scroll” also enables listing of audio data files and/or video data files stored in the communication device 150, and/or controllable from the communication device 150 in a proxy manner in association with one or more remote databases. “Hide a contact” causes a given contact to be retained in the data memory 170 and/or in the one or remote databases 120 but not to be shown in the action functionality 210, for example to prevent an amount of data presented via the action functionality 210 becoming unwieldy for the given user, namely to avoid causing information overload to the given user. “Pin a contact” provides for a given contact presented on the user interface 190 to be highlighted, or otherwise marked, as being of special importance, for example a special status, and to be retained; alternatively, “Pin a contact” can be invoked to make a call to the customer. “Change status” enables a status designation of a given contact to be changed by the given user. “Add a contact” provides for the given user to add a new contact to the list of contacts of the given user. “See my profile” provides for the given user to view his or her personal profile, for example as communicated via the communication network 110 to other users.

The discovery/feeds functionality 220 provides for the given user to access a social magazine, namely a news portal in magazine format, which is implemented via one or more data feeds from the one or more remote databases 120 and/or directly from the communication devices of other users of the system 100. Optionally, the magazine is a compilation of content provided from the given user's favourite contacts' services, for example implemented via contemporary proprietary Facebook, Linked in, Twitter and similar; “Facebook”, “Linked in” and “Twitter” are registered trade marks. It provides an exit point for the given user to access via the user interface 190 other users' pages. Moreover, it further provides an exit from such other users' pages.

As aforementioned, from the action functionality 210, the given user is able by interacting with the user interface 190 to migrate between the timeline page 200, the person page 240, and the discovery page 250. Moreover, the given user is also able, from the action functionality 210 to access the profile page (“My profile”) 260 and the search results page (“Search results”) 270. The timeline page 200 provides the given user with a unified communication log between the given user and another specific user; optionally, different formats of communication are included in the unified log, for example voice communication, SMS communications, Twitter communications, audio data file and/or video data file downloading, viewing and dissemination to one or more other users, and so forth. The person page 240, when invoked by the given user, provides more details regarding the aforesaid specific user, for example a larger profile picture of the specific user, for example a person, company or organisation, together with name and spatial location information; optionally, the spatial location information is a contact address and/or a real-time updated indication of a spatial location of the specific user. The discovery page 250 provides a magazine composed of public content made available by the specific user; optionally, the magazine is compiled from information extracted from multiple sources and databases, thereby providing the given user with a rapid overview of the specific user and recent developments which may pertain to the specific user. Moreover, the discovery page 250 provides for the given user to retweet any comments regarding the specific user. The profile page (“My profile”) 260 provides the given user with an opportunity for the given user to amend and update his or her own personal information, for example as experienced by other users of the system 100. Optionally, the profile page 260 provides for the given user to edit personal information, to set privacy parameters, for example “public”, “share to specified users”, parameters to indicate that the given user's personal information should be shared with other users. Finally, search results page (“Search results”) 270 provides the given user with a searching function for searching details of other users, as well as information, for example catalogues, stored at the one or more remote databases 120.

Aforesaid “Life Beat” implemented in the system 100 is capable of providing the following main functions:

(a) ME: one unified contact
The given user manages his or her own contact details:
Use case 1: When I change my telephone number, my contact information in other Life Beat users' address books will be corresponding updated automatically.
Use case 2: When I have more than one telephone number, the Life Beat users can see which of my telephone numbers are active at a given time, and which of my telephone numbers are inactive.
The system 100 is configured, arranged or otherwise operable to enable such automatic updating to occur in real time.

### (b) VIRAL

The user is able to share content with other users:
Use case 1: When I find an article/photograph within a social magazine or person's magazine hosted by the system 100, I am able to share that article/photograph. When I share/retweet/comment, the article/photograph when shared will be accompanied the Life Beat name, for example “Shared via Life Beat”.
Use case 2: When I publish my status via the system 100, it carries an associated label “Published via Life Beat”.
Use case 3: Periodically, favourite (“fave”) users in my address book are delivered a magazine which is a compilation of information from magazines of my favourite users of the system 100.

### (c) SHARE AND UNIFIED NUMBER

The system 100 provides the given user with multiple ways of sharing the given user's contact details, for example via QR codes, via simple sharing with other users, for example when embedded into communications such as SMS communications, e-mails and similar.
Use case 1: When user Maria shares my contact details with another person, I will receive an app-pushed (i.e. application-software-pushed) notification, for example “Maria Lopez shared your contact telephone number with Daniel Woods in Life Beat”.
Use case 2: Life Bear is set up for a digitally uncomfortable person. Her children and friends (digitally comfortable) can help her to add contacts by simply sharing theirs to her. She does not need to insert everyone else's contact details one by one.

(d) MULTIPLE CONTACTS OF SAME USER ARE AUTOMATICALLY COMBINED INTO ONE CONTACT DETAIL

Use case 1: Users do not have to combine contacts in a manual manner from different services.
Such automatic combining of contact information avoids the given being overloaded with excessive contact information content at the user interface 190 when using the Life Beat software application.

### (e) SEARCH

The given user is capable, via the system 100, of searching not only within his or her Life Beat data, but also public contacts in Life Beat data of the given user's friends, namely other friendly users of the system 100.
Use case 1: I need a carpenter. Instead of searching through a Yellow Pages telephone directory or similar, I go to my Life Beat and search for “carpenter”. I would rather get the number for the carpenter of my friend's trust-worthy carpenter, rather than a random carpenter from the Yellow Pages.
“Yellow Pages” is a registered trade mark. Use of the term “Yellow Pages” is not intended here to be in any form of negative comment in respect of this trade mark.

### (f) DYNAMIC PRIVACY SETTINGS

The Life Beat innovation allows for privacy levels to be set for each item in a contact card; however, such privacy level can be set automatically as a function of a social group of the given user.
User case 1: I have one business contact number and one private contact number. I only want certain people to have my private contact number, whilst my business contact number can be public to everyone.

Examples of information presented to the given user via the user interface 190 when using the system 100 are illustrated in FIG. 4 to FIG. 6.

In FIG. 4, the timeline functionality 200 is illustrated wherein a user Samantha Jones is shown to have rung 12 minutes ago from Madrid, wherein an e-mail regarding something being true is shown as being received 1 hour ago, a brief communication (e.g. SMS) is shown as being received from Blou Armstrong 4 minutes ago, and a Facebook (FB) communication is shown received 34 minutes ago bearing a message “Can you come in now?”. The timeline functionality 200 is thus capable, in a concisely and rapidly appreciated manner, of providing the given user with latest communication received from various sources and via various communication channels.

Referring next to FIG. 5, in the home functionality 210, various contact details are shown ranging from main contacts of the given user, for example “Mum”, “Rebecca”, “Benjamin”, “John”, “William”, “Maria”, “John”, “William” and “Maria” again. Below, these main contacts are shown an A-Z of near groups, for example “Amalia Rosario”, “Barbara White” and “Benjamin Woo”. Favourites of the given user are presented at a top of the user interface 190, and other lesser significant contacts for the given user are presented at a lower portion of the user interface 190. Optionally, the A-Z of near groups is implemented in a scrollable manner on the user interface 190.

Referring next to FIG. 6, in the discovery/feeds functionality 220, there is magazine content from a plurality of contacts of the given user, for example a Facebook-derived image with an identification of its source (i.e. “Mum”), a Twitter-derived image with comment that “ . . . the party was great !” posted 2 hours ago, and another Facebook-derived image together with a comment “ . . . James just posted a picture”. Moreover, text information is additionally included to inform: “ . . . Rebecca is now friends with Benjamin”.

As aforementioned, the communication device 150 of the given user, when executing computer readable instructions of a software application on the computing hardware 160 for implementing the present Life Beat invention, is configured, arranged or otherwise operable to provide the collection of functionalities, including the timeline functionality 200, the action functionality 210 acting as a “home page” for actions (“Actions”) and for launching functionalities (“Quick Launcher”), and the discovery/feed functionality 220. From the action functionality 210, the given user is able by interacting with the user interface 190 to migrate between the timeline page 200, the person page 240, and the discovery page 250. Moreover, the given user is also able, from the action functionality 210 to access the profile page (“My profile”) 260 and the search results page (“Search results”) 270. An example of these pages is provided in FIG. 7A and FIG. 7B. In FIG. 7A, an example of the timeline is shown, wherein there are a plurality of channels, for example telephony, e-mail, Twitter and Facebook provided horizontally across the user interface 190 as viewed by the given user. Communication events are represented by icons included along the channels in a chronological order with a passage of time from left to right across the user interface 190. Each icon, for example on icon 300, includes text details of a name of party who has sent a communication represented by the icon 300, for example attempted a telephone call or sent an SMS message, together a time elapsed since the communication was sent or made. Channels' icons 310 act as a quick access to the corresponding apps in the home page. Optionally, the given user is able to scroll along the timeline by applying a finger or thumb swiping motion to a surface of the user interface 190, for example when implemented as a touch-screen display. A given user may flick his or her finger horizontally left or right across the surface of the user interface 190 to reveal the timeline, flick his or her finger up or down vertically to go through the channels or pull up the panel at the bottom to open the account settings. It should be noted that different gestures may also be used. In an event that a communication corresponding to given icon 300 is of interest to the given user, the given user is able to tap a stylus, finger or thumb on the icon 300 to invoke a presentation of contact details of the person who sent the communication, as illustrated in FIG. 7B. Optionally, a view of near contacts associated with the person who sent the communication, may also be presented.

The present invention provides a considerable improvement in respect of known technology for managing communications using a wireless communication device. It enables the given user to have a clear oversight of his or her portfolio of contacts and associated instances of communication using a communication system including a distributing arrangement of computing hardware. Beneficially, data supporting the aforesaid functionalities provided via the user interface 190 are also stored on the one or more remote databases 120, so that the given user is able to import all his or her contacts onto a new mobile communication device in an event that the given user moves to another communication platform, for example a latest model of smart telephone.

The present invention is also, beneficially, capable of providing a social media platform for temporally logging one or more of:

(i) first user-viewing and/or user-listening of video and/or audio data files respectively;
(ii) first user downloading or uploading of such data files; and
(iii) dissemination of such data files to other users.
Optionally, such temporal logs are uploaded from the communication device 150 to a remote monitoring database. Optionally, the monitoring database is configured, arranged or otherwise operable to aggregate data indicative of first viewing, subsequent viewing, and dissemination of such data files. Such aggregated data is beneficial for determining a degree of data file dissemination, communication paths of such data file dissemination, and histories of dissemination of such data file dissemination. Optionally, such aggregated determination is capable of being used for assessing a degree of copyright infringement of audio and/or video content. Moreover, real time marketing information of dissemination of advertising content can also be determined, for example for providing real-time reports of effectiveness of marketing campaigns via devices such as the communication device 150.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

We claim:

1. A wireless communication device data logging and access system, wherein the system includes a communication network coupled in communication with one or more databases and one or more mobile wireless communication devices, wherein each mobile wireless communication device includes computing hardware coupled to a data memory, to a wireless communication interface for exchanging data wirelessly with the communication network, and to a user interface for receiving instructions from a given user and for presenting information to the given user, and wherein the computing hardware is operable to execute computer readable instructions of one or more software applications stored in the data memory, wherein execution of the computer readable instructions of the one or more software applications is operable to cause the wireless communication device:
(i) to generate a temporal log of communications made to and from the wireless communication device, for enabling graphical timeline presentations of the communications to be provided in chronological order via the user interface in one or more channels depending upon a nature of the communications;
(ii) to generate at least one of lists and icon presentations on the user interface of parties responsible for the communications and a representation of their mutual association; and
(iii) to generate a news portal of content published by the parties responsible for the communications.

2. The wireless communication device data logging and access system as set forth in claim 1, wherein data representative of the parties responsible for the communications are stored at least in duplicate in the data memory of the wireless communication device and on the one or more databases.

3. The wireless communication device data logging and access system as set forth in claim 1, wherein the wireless communication device is implemented as a smart mobile telephone, and the user interface is implemented as a touch-screen pixel display for enabling the given user to enter data to the wireless communication by swiping and/or tapping actions applied to the display.

4. The wireless communication device data logging and access system as set forth in claim 1, wherein the graphical timeline presentations are configured to scroll on the user interface by way of the given user applying a swiping motion in contact with the user interface.

5. The wireless communication device data logging and access system as set forth in claim 1, wherein the system is configured so that the given user is able to send a request via the communication network to search in contact lists of other parties which are associated with the given user.

6. The wireless communication device data logging and access system as set forth in claim 5, wherein the system is configurable to define the other parties which are accessible to the given user for searching purposes.

7. The wireless communication device data logging and access system as set forth in claim 1, wherein the one or more software applications are operable to provide editing functionality for the given user to manage his or her list of parties contactable via the system.

8. The wireless communication device data logging and access system as set forth in claim 1, wherein the system is configured to enable the given user to contribute content to be included in the news portal of other parties of the system.

9. The wireless communication device data logging and access system as set forth in claim 1, wherein the system is configured to log at least one of:
(a) first downloading of audio and/or video data files to one or more mobile wireless communication devices;
(b) occasions of viewing and/or listening to audio and/or video data files; and
(c) dissemination of audio and/or video data files from a mobile wireless communication device to one or more mobile wireless communication devices.

10. A method of operating a wireless communication device data logging and access system, wherein the system includes a communication network coupled in communication with one or more databases and one or more mobile wireless communication devices, wherein each mobile wireless communication device includes computing hardware coupled to a data memory, to a wireless communication interface for exchanging data wirelessly with the communication network, and to a user interface for receiving instructions from a given user and for presenting information to the given user, and wherein the computing hardware is operable to execute one or more software applications stored in the data memory, wherein the method includes:
(i) using the one or more software applications to cause the wireless communication device to generate a temporal log of communications made to and from the wireless communication device, for enabling a graphical timeline presentations of the communications to be provided in chronological order via the user interface in one or more channels depending upon a nature of the communications;
(ii) using the one or more software applications to cause the wireless communication device to generate lists and/or icon presentations on the user interface of parties responsible for the communications and a representation of their mutual association; and
(iii) using the one or more software applications to cause the wireless communication device to generate a news portal of content published by the parties responsible for the communications.

11. The method as set forth in claim 10, further comprising storing data representative of the parties responsible for the communications at least in duplicate in the data memory of the wireless communication device and on the one or more databases.

12. The method as set forth in claim 10, further comprising implementing the wireless communication device as a smart mobile telephone, and implementing the user interface as a touch-screen pixel display for enabling the given user to enter data to the wireless communication by swiping and/or tapping actions applied to the display.

13. The method as set forth in claim 10, further comprising implementing the graphical timeline presentations in a scrollable manner on the user interface, wherein the graphical timeline presentations are thereby configured to scroll by way of the given user applying a swiping motion in contact with the user interface.

14. The method as set forth in claim 10, further comprising implementing the system so that the given user is able to send a request via the communication network to search in contact lists of other parties which are associated with the given user.

15. The method as set forth in claim 14, further comprising configuring the system to define the other parties which are accessible to the given user for searching purposes.

16. The method as set forth in claim 10, wherein the one or more software applications are configured to enable editing functionality for the given user to manage his or her list of parties contactable via the system.

17. The method as set forth in claim 10, further comprising configuring the system to enable the given user to contribute content to be included in the news portal of other parties of the system.

18. The method as set forth in claim 10, further comprising logging at least one of:
(a) first downloading of audio and/or video data files to one or more mobile wireless communication devices;
(b) occasions of viewing and/or listening to audio and/or video data files; and
(c) dissemination of audio and/or video data files from a mobile wireless communication device to one or more mobile wireless communication devices.

19. A software product recorded on non-transient machine-readable data storage media, wherein the software product is executable upon computing hardware for implementing a method as set forth in claim 11.

20. The software product as set forth in claim 19, wherein the software product is downloadable as a software application from one or more databases via a communication network to one or more mobile communication devices for execution upon computing hardware thereof.
